(19) United States
(12) Patent Application Publication
(10) Pub. No.: US 2017/0336356 A1
(43) Pub. Date: Nov. 23, 2017

(54) METHODS AND SYSTEMS FOR CROSS-TALK ELIMINATION IN CONTINUOUS BEAM MOBILITY-BASED SPECTROMETERS

(71) Applicant: DH Technologies Development PTE Ltd., Singapore (SG)

(72) Inventors: Thomas R Covey, Newmarket (CA); Yang Kang, Richmond Hill (CA); Frank Londry, Peterborough (CA); Bradley B Schneider, Bradford (CA)

(21) Appl. No.: 15/520,867

(22) PCT Filed: Oct. 21, 2015
(86) PCT No.: PCT/IB2015/058129

§ 371 Date: Apr. 21, 2017

Related U.S. Application Data
(60) Provisional application No. 62/067,217, filed on Oct. 22, 2014.

(51) Int. Cl. G01N 27/62; H01J 49/00; H01J 49/06; H01J 49/24

(52) U.S. Cl. CPC G01N 27/624; H01J 49/24; H01J 49/0031; H01J 49/06

(57) ABSTRACT

A sample analysis system having a continuous beam ion mobility filter incorporates an ion removal mechanism for removing residual ions from the ion mobility filter to reduce cross-talk. A sample to be analyzed by the sample analysis system can be entered into the continuous beam ion mobility filter, which filters the ions of the sample and passes the filtered group of ions to a detector or a mass analyzer (e.g., via an ion optics assembly disposed between the mass analyzer and the ion mobility filter), where some or all of the ions in the group are detected. The ion removal mechanism then removes all or a substantial portion of the residual ions from the ion mobility filter that are left over from the first filtered group before a second filtered group is passed through. In some aspects, the ion removal mechanism can be operated concurrent with an ion removal mechanism for removing residual ions from an ion optics assembly.

### RELATED APPLICATIONS

This application claims the benefit of priority from U.S. Provisional Application Ser. No. 62/067,217, filed on Oct. 22, 2014, the entire contents of which is incorporated by reference.

This application is related to U.S. patent application Ser. No. 12/722,863 filed Mar. 12, 2010 (now U.S. Pat. No. 8,350,212), entitled “Ion Optics Drain for Ion Mobility,” which claims the benefit of priority of U.S. Provisional Application No. 61/160,925, filed Mar. 17, 2009, all of which are incorporated herein in their entireties.

This application is also related to U.S. Provisional Application Nos. 61/922,275 filed Dec. 31, 2013, entitled “Jet Injector Inlet for a Differential Mobility Spectrometer,” and 61/935,741 filed Feb. 4, 2014, entitled “Jet Injector Inlet for a Differential Mobility Spectrometer,” the teachings of which are incorporated by reference in their entireties.

### FIELD

The present teachings generally relate to mass spectrometry, and more particularly to methods and systems for cross-talk elimination in continuous beam, mobility-based spectrometers.

### BACKGROUND

Ion mobility-based analysis methods separate and analyze ions based upon differences in the mobility of the particular analytes through a gas, typically at elevated pressures (e.g., near atmospheric pressure) relative to the vacuum chambers utilized in most mass analyzers. In conventional low field ion mobility-based methods, ions pass through a drift tube and interact with drift gas molecules while being subject to an electric field. These interactions, which can be specific for each ion species, can lead to a separation of ions due to differences in velocity or trajectory of the species through the drift tube based on their different mobility characteristics. In contrast, in collision-free vacuum conditions of a Time of Flight Mass Spectrometer (ToF-MS), for example, an ion's flight time through the MS flight tube is generally determined by the ion's mass-to-charge ratio (m/z).

Alternatively, some mobility-based separation devices such as differential mobility spectrometers (DMS), Field Asymmetric Waveform Ion Mobility Spectrometers (FAIMS), and differential mobility analyzers (DMA) can provide a continuous beam of ions separated based on the ions' mobility or differential mobility, in order to analyze and/or quantify one or more analytes in a sample. For example, DMS and FAIMS differ from low field mobility devices in that ions are subjected to alternating periods of high and low electric fields and separation is based upon the difference between an ion's high and low field mobility. These devices provide significant advantages over traditional drift tube mobility devices, which involve pulsing of ions into a drift tube and are therefore not able to provide continuous beams of ions. Moreover, as a result of their operability at or near atmospheric pressure, continuous beam mobility-based separation devices are commonly incorporated into the front end of a mass spectrometer system to receive ions from an ion source and provide a filtered, continuous beam of ions to a downstream mass analyzer for further analysis, thereby providing added selectivity. By way of non-limiting example, a differential mobility spectrometer can be interfaced with a mass spectrometer (MS) to provide an additional separation method to the MS to take advantage of the atmospheric pressure, gas phase, and continuous ion separation capabilities of the DMS and the enhanced analytical power of the DMS-MS system. By interfacing a DMS with an MS, numerous areas of sample analysis, including proteomics, peptide/protein conformation, pharmacokinetic, and metabolism analysis have been enhanced. In addition to pharmaceutical and biotech applications, DMS-based analyzers have been used for trace level explosives detection and petroleum monitoring.

Though such systems can allow for multiple, different analytes to be monitored simultaneously and/or continuously, the ion residence time in the ion mobility filter or the atmospheric pressure region or regions between the ion mobility filter and the vacuum inlet of the mass spectrometer can cause chemical cross-talk between different analytes. Chemical cross-talk occurs when ions from one sample (or a portion thereof) contaminate data obtained on ions from another sample (or a portion of the sample).

Accordingly, there remains a need for improved elimination of chemical cross-talk in systems incorporating continuous beam, mobility-based spectrometers.

### SUMMARY

The systems and methods described herein remove residual ions from mobility-based spectrometers and systems utilizing the same in order to reduce or eliminate chemical cross-talk between chemical species in a continuous ion beam. Though previous attempts at reducing cross-talk have focused on draining residual ions from the downstream ion optics assembly or a mass analyzer within the vacuum chamber, subsequent advances in ion sources and ion mobility devices have not only led to increased transmission of ions (e.g., greater sensitivity), but also increased cross-talk between isobaric compounds in the sample. An increased offset distance between the ion mobility filter and the inlet orifice has also been discovered to exacerbate problems associated with cross-talk.

The exemplary systems and methods described herein incorporate an ion removal mechanism in the sample analysis system for removing residual ions from the continuous beam ion mobility filter and/or from the coupling region between the ion mobility filter and the vacuum chamber housing the mass analyzer(s), e.g., so as to eliminate cross-talk during analysis of ions transmitted by the ion mobility filter. In some aspects, a sample to be analyzed by the sample analysis system can be entered into the continuous beam ion mobility filter, which filters the ions of the sample and passes the filtered group of ions to a detector or a mass analyzer (e.g., via an ion optics assembly disposed between the mass analyzer and the ion mobility filter), where some or all of the ions in the group can be detected. The ion removal mechanism then removes all or a substantial portion of the residual ions from the ion mobility filter that are left over from the first filtered group before a second filtered group is passed through the ion mobility filter to a downstream detector, ion optics assembly, or mass analyzer. In some aspects, the systems and methods can additionally remove residual ions from the ion optics assembly as described, for example, in U.S. Pat. No. 8,350,212, which is incorporated by reference in its entirety. For example, the ion removal mechanisms of the ion mobility filter and the ion optics assembly can be operated simultaneously to help reduce cross-talk between groups of selected ions.

In accordance with various aspects of the applicant's present teachings, a sample analysis system is provided, comprising a continuous beam ion mobility filter for receiving ions from an ion source and having an internal operating pressure at or near atmospheric pressure, the ion mobility filter configured to selectively pass through a first group of ions based on the mobility characteristics of the first group of ions; a detector configured to detect the first group of ions or fragments thereof; and an ion removal mechanism for removing residual ions of the first group of ions from the ion mobility filter.

The continuous beam ion mobility filter can have a variety of configurations. The first groups of ions can be entrained in a gas flow through the ion mobility filter and/or can be driven axially through the ion mobility filter by an axial electric field. By way of non-limiting example, the ion mobility filter can be one of a Field Asymmetric Ion Mobility System (FAIMS), Differential Mobility Spectrometer (DMS), or Differential Mobility Analyzer (DMA).

Residual ions (e.g., ions from a first group of filtered ions) can be removed from the ion mobility filter using a variety of mechanisms (e.g., electrically, pneumatically, mechanically). In one aspect, for example, removing residual ions from the ion mobility filter can comprise generating an electric field to radially de-focus substantially all ions within the ion mobility filter. In one aspect, a DC bias voltage applied between filter electrodes of the ion mobility filter can be increased such that substantially all ions within the ion mobility filter are neutralized at the filter electrodes. For example, the ion mobility filter can comprise at least one pair of filter electrodes defining an ion flow path therebetween, the filter electrodes configured to generate an electric field for filtering the first group of ions based on the mobility characteristics of the first group of ions, and a voltage source for providing RF and DC voltages to at least one of the filter electrodes to generate the electric field, wherein removing residual ions from the ion mobility filter can comprise increasing a DC bias voltage applied between the filter electrodes such that substantially all ions within the ion mobility filter are neutralized at the filter electrodes (including ions within the first group of ions that are transmitted during a first time period). In some aspects, ions can additionally or alternatively be removed from the mobility filter pneumatically by reducing or eliminating the transport gas flow, or by providing additional gas flows to disrupt ion motion. In other aspects ions can be removed mechanically by providing blocking or diverting devices or shutters.

In one aspect, the ion removal mechanism can increase a compensation voltage applied between electrodes of the ion mobility filter and an amplitude of the DC offset voltage applied to each of the electrodes. For example, in one aspect, the ion mobility filter can comprise at least one pair of filter electrodes defining an ion flow path therebetween, the filter electrodes configured to generate an electric field for passing through the first group of ions based on the mobility characteristics of the first group of ions; and a voltage source for providing RF and DC voltages to at least one of the filter electrodes to generate the electric field. A controller can be operatively coupled to the ion mobility filter and the detector for controlling operation thereof. In related aspects, the controller can include a timer for defining at least a first period representative of a time for passing through the first group of ions, and at least a second period for operating the ion removal mechanism to remove residual ions (e.g., ions from the first group of ions) from the ion mobility filter. For example, the controller can be configured to increase a DC bias voltage applied between the filter electrodes during the second period relative to the first period such that substantially all ions within the ion mobility filter are neutralized at the filter electrodes during the second period (including residual ions from the first group of ions). Additionally or alternatively, the controller can be configured to increase an amplitude of a DC voltage applied to each of the at least one pair of filter electrodes during the second period relative to the first period.

In certain aspects, the sample analysis system can further comprise an ion optics assembly and a mass analyzer disposed between the ion mobility filter and the detector, wherein the ion optics assembly and mass analyzer are disposed within a vacuum chamber, and wherein a coupling region is disposed between an outlet end of the ion mobility filter and an inlet orifice of the vacuum chamber. In related aspects, the ion removal mechanism can be configured to increase an axial velocity of ions within the coupling region. In some aspects, a controller can be operatively coupled to the ion mobility filter, the ion optics assembly, the mass analyzer, and the detector for controlling operation thereof, wherein the controller comprises a timer for defining at least a first period representative of a time for passing the first group of ions through the ion mobility spectrometer, and at least a second period for operating the ion removal mechanism to remove residual ions from at least one of the ion mobility filter and the coupling region. A second ion removal mechanism can also be configured to remove residual ions from the ion optics assembly during the second period. For example, the controller can be in communication with the second ion removal mechanism for decreasing an RF potential within the ion optics assembly to de-focus and remove ions from within the ion optics assembly during the second period. In some aspects, the ion mobility filter can be located in a first pressure region (e.g., near atmospheric pressure), the mass analyzer located in a second pressure region different from the first pressure region, and the ion optics assembly located in a third pressure region intermediate to the pressures in the first and second pressure regions.

In accordance with various aspects of the present teachings, a sample analysis system is provided, comprising: a continuous beam ion mobility filter for receiving ions from an ion source and configured to filter and transmit a first group of ions therethrough; a mass analyzer housed within a vacuum chamber and in fluid communication with the ion mobility filter for analyzing the first group of ions; a coupling region disposed between an outlet end of the ion mobility filter and an inlet orifice of the vacuum chamber for transporting the first group of ions from the ion mobility filter to an inlet orifice of the vacuum chamber; and an ion removal mechanism for removing residual ions from the ion mobility filter and/or the coupling region. In some aspects, the sample analysis system can also include an ion optics assembly for transporting the first group of ions from the ion mobility filter to the mass analyzer. In accordance with various aspects of the present teachings, the system can also include a controller operatively coupled to the ion mobility filter, the ion optics assembly, and the mass analyzer for controlling their operation, wherein the controller comprises a timer for defining at least a first period representative of a time for passing the first group of ions through the ion mobility spectrometer and at least a second period for operating the ion removal mechanism to remove residual ions from the ion mobility filter and the coupling region.

The ion optics assembly can also have a variety of configurations, and in some aspects, a second ion removal mechanism can also be provided for removing ions from the ion optics assembly. By way of non-limiting example, the ion optics assembly can be selected from the group consisting of multipole array, ring guide, ion funnel, and traveling wave device. In some aspects, a controller can be configured to operate the ion removal mechanism to remove ions from the ion mobility filter and the coupling region concurrent with operating a second ion removal mechanism to remove ions from the ion optics assembly. For example, a DC potential can be applied to at least two poles of the multipole array so as to remove residual ions from the ion optics assembly. For example, in one aspect, the second ion removal mechanism can include a power supply for applying a DC potential to at least two poles of the multipole array configured to remove residual ions from the ion optics assembly. The second ion removal mechanism can utilize a DC potential to create an electric field between at least two of the poles of the multipole array to expel the residual ions away from the ion optics assembly. Alternatively or additionally, an RF potential within the ion optics assembly can be decreased to de-focus the ions and remove the ions from the ion optics assembly. In yet another aspect, the second ion removal mechanism can include at least one electrode in communication with a power supply for generating a DC potential to remove residual ions from the ion optics assembly. The second ion removal mechanism can generate a DC potential to create an electric field that expels the residual ions radially out of the ion optics assembly. The second ion removal mechanism can additionally or alternatively generate a DC potential to create an axial electric field that expels residual ions out of the ion optics assembly.

In one aspect, the second ion removal mechanism includes at least one electrode in communication with a power supply for generating a DC potential to accelerate ion motion through the ion optics assembly. In another aspect, the controller can be in communication with the second ion removal mechanism for decreasing or removing the RF potential within the ion optics assembly to de-focus the ions and remove the ions from the ion optics assembly during the second period (e.g., concurrent with the removal of ions from the ion mobility filter).

In some aspects, the ion mobility filter can be located in a first pressure region, the mass analyzer in a second pressure region different from the first pressure region, and the ion optics assembly in a third pressure region intermediate to the pressures in the first and second pressure regions. By way of example, the first pressure region can be near atmospheric pressure.

The continuous beam ion mobility filter can have a variety of configurations. By way of non-limiting example, the ion mobility filter can be one of FAIMS, DMS, and DMA.

In some aspects, the ion mobility spectrometer can comprise at least one pair of filter electrodes defining an ion flow path therebetween, the filter electrodes configured to generate an electric field for passing through the first group of ions based on the mobility characteristics of the first group of ions; and a voltage source for providing RF and DC voltages to at least one of the filter electrodes to generate the electric field. In a related aspect, a controller operatively coupled to the ion mobility filter for controlling operation thereof can comprise a timer for defining at least a first period representative of a time for passing through the first group of ions, and at least a second period for operating the ion removal mechanism to remove residual ions from the ion mobility filter and the coupling region. By way of example, the controller can be configured to increase a DC bias voltage applied between the filter electrodes during the second period relative to the first period such that substantially all ions within the ion mobility filter are neutralized at the filter electrodes during the second period. Alternatively or additionally, the controller can be configured to increase an amplitude of a DC voltage applied to each of the at least one pair of filter electrodes during the second period relative to the first period. In various aspects, the ion removal mechanism can be configured to increase an axial velocity of ions within the coupling region.

In some aspects, the ion removal mechanism increases a compensation voltage applied between electrodes of the ion mobility filter and an amplitude of the DC offset voltage of the electrodes relative to a downstream mass spectrometer inlet orifice or tube, referred to as DMS offset or DMO.

In various aspects, the vacuum chamber can maintain the mass spectrometer at a vacuum pressure lower than an internal operating pressure of the ion mobility filter, the vacuum chamber being operable to draw a gas flow including the first group of ions through the ion mobility filter and into the vacuum chamber via the inlet orifice.

Sample analysis systems in accordance with the present teachings can also comprise an ion source for generating a plurality of ions, which can be received and filtered by the continuous beam ion mobility filter.

In accordance with various aspects of the applicant's teachings, a method for analyzing a sample is also provided, comprising: receiving at an inlet end of a continuous beam ion mobility filter a plurality of ions generated by an ion source; filtering a first group of ions of the plurality of ions with the ion mobility filter based on the mobility characteristics of the first group of ions; transporting the first group of ions or fragments thereof to a detector; and removing residual ions (e.g., ions of the first group of ions) from the ion mobility filter. In some aspects, filtering and transporting the first group of ions occurs during a first period of time, and wherein removing residual ions from the ion optics assembly occurs during a second time period. In a related aspect, the method can also comprise filtering a second group of ions of the plurality of ions with the ion mobility filter based on the mobility characteristics of the second group of ions; transporting the second group of ions or fragments thereof to a detector, wherein filtering and transporting the second group of ions from the ion mobility filter to the mass analyzer occurs during a third time period after the second time period.

In various aspects, an ion optics assembly and a mass analyzer can be in fluid communication with the ion mobility filter, the ion optics assembly and mass analyzer being housed within a vacuum chamber at a pressure lower than an internal operating pressure of the ion mobility filter, the vacuum chamber being operable to draw a gas flow including the first group of ions through the ion mobility filter and into the vacuum chamber via an inlet orifice. In one aspect, the method can also include removing residual ions from the ion optics assembly simultaneous with removing residual ions from the ion mobility filter.

Additionally, in some aspects, a coupling region can be disposed between an outlet end of the ion mobility filter and an inlet orifice of the vacuum chamber, and the method can further comprise removing residual ions from the coupling chamber. By way of example, an axial electric field can be generated by increasing the DC offset of the electrodes of the ion mobility filter relative to the inlet orifice of the vacuum chamber so as to accelerate the ions towards the vacuum chamber (e.g., expel the residual ions out of the coupling chamber). Alternatively, additional electrodes can be used to radially extract ions from the gas flow, or radial or counter-current gas flows can be used to sweep residual ions away from the inlet orifice.

In accordance with various aspects of the applicant's teachings, a method for analyzing a sample is provided, comprising: A. filtering, based on ion mobility, a first portion of ions using a continuous beam ion mobility filter coupled to a vacuum inlet orifice of a mass analyzer and transmitting, using an ion optics assembly, the first portion of ions to the mass analyzer during a first time period; B. filtering, based on ion mobility, a second portion of ions and transmitting, using the ion optics assembly, the second portion of ions to the mass analyzer during a second time period; and C. emptying residual ions from the continuous ion mobility filter and the ion optics assembly during a third time period, the third time period occurring between the first and second time periods. Steps A-C can be iteratively repeated (e.g., with ions having the same or different mobility characteristics as the first and second portions). In some aspects, a coupling chamber can be disposed between the ion mobility filter and the vacuum inlet orifice, and ions within the coupling chamber can either be accelerated toward the vacuum inlet orifice or directed away from the vacuum inlet orifice during the third time period.

These and other features of the applicant's teachings are set forth herein.

### BRIEF DESCRIPTION OF THE DRAWINGS

The foregoing and other objects and advantages of the invention will be appreciated more fully from the following further description, with reference to the accompanying drawings. The skilled person in the art will understand that the drawings, described below, are for illustration purposes only. The drawings are not intended to limit the scope of the applicant's teachings in any way.

FIG. 1, in schematic diagram, illustrates an exemplary sample analysis system in accordance with aspects of various embodiments of the applicant's teachings;

FIG. 2A depicts an exemplary timing diagram for generating an asymmetric electric field in a DMS filter in use as the ion mobility filter of FIG. 1;

FIG. 2B depicts an exemplary timing diagram for operating the filter electrodes in the DMS filter of FIG. 2A;

FIG. 2C, in schematic diagram, depicts exemplary paths for groups of ions within the DMS filter subjected to the combined electric fields of FIGS. 2A and 2B;

FIG. 3, in schematic diagram, illustrates another exemplary sample analysis system in accordance with aspects of various embodiments of the applicant's teachings;

FIG. 4 depicts a timing diagram for operation of the ion optics assembly of FIG. 4;

FIG. 5 depicts, in schematic diagram, a cross-sectional view of ion optics assembly suitable for use in the system of FIG. 3;

FIG. 6 depicts, in schematic diagram, a cross-sectional view of the ion optics assembly of FIG. 5 during the drain period;

FIG. 7 depicts an exploded view of another exemplary sample analysis system in accordance with aspects of various embodiments of the applicant's teachings;

FIG. 8A depicts an exemplary timing diagram for generating an asymmetric electric field in the DMS filter of FIG. 7;

FIG. 8B depicts an exemplary timing diagram for operating the filter electrodes in the DMS filter of FIG. 7;

FIG. 8C, in schematic diagram, depicts exemplary paths for groups of ions within the DMS filter subjected to the combined electric fields of FIGS. 8A and 8B;

FIG. 9 depicts data demonstrating increase in crosstalk in an improved DMS inlet design; and

FIG. 10 depicts exemplary data demonstrating increase in crosstalk in systems having increased lengths between the ion mobility filter and the inlet orifice.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that some embodiments of the applicant's teachings may not require certain of the specifically described details in every implementation, which are set forth herein only to provide a thorough understanding of the embodiments. Similarly it will be apparent that the described embodiments may be susceptible to alteration or variation according to common general knowledge without departing from the scope of the disclosure. The following detailed description of embodiments is not to be regarded as limiting the scope of the applicant's teachings in any manner.

Methods and systems for removing residual ions from continuous beam mobility-based spectrometers and systems utilizing the same are provided herein. In accordance with various aspects of the applicant's teachings, the methods and systems can reduce or eliminate chemical cross-talk between chemical species in a continuous ion beam, including in systems having increased transmission of ions (e.g., due to improved coupling between the ion source and the ion mobility filter) and/or in systems having an increased offset distance between the ion mobility filter and the inlet orifice, in which applicant has discovered that problems associated with chemical cross-talk can be exacerbated. In various aspects, the systems and methods described herein incorporate an ion removal mechanism for removing all or a substantial portion of a first group of residual ions within an ion mobility filter before a second filtered group is passed through the ion mobility filter to a downstream detector, ion optics assembly, or mass analyzer(s). In accordance with various aspects, the ion removal mechanism can additionally or alternatively remove all or a substantial portion of residual ions within a coupling region disposed between the ion mobility filter and a vacuum chamber housing the mass analyzer(s).

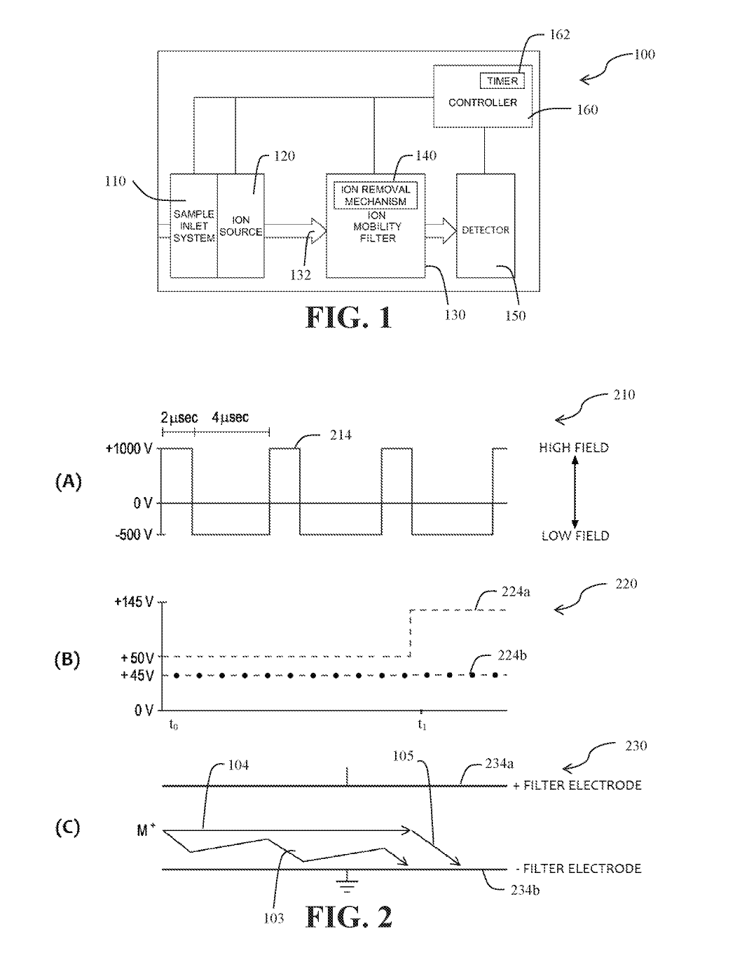

With reference now to FIG. 1, an exemplary sample analysis system 100 having an ion removal mechanism 140 in accordance with various aspects of the present teachings is depicted in schematic view. The depicted mass spectrometer system 100 comprises a sample inlet system 110, an ion source 120, a continuous beam ion mobility filter 130, the ion removal mechanism 140, and a detector 150. As discussed in detail below, the ion mobility filter 130 can continuously receive ions from the ion source 120 and transmit a first group of those ions (i.e., filter the first group of ions based on their mobility characteristics) to the downstream detector 150 during a first time period, remove residual ions from the first group of ions from within the ion mobility filter 130 utilizing the ion removal mechanism 140 during a second time period after the first time period, and transmit a second group of ions through the ion mobility filter 130 to the detector 150 during a third time period after the second time period so as to eliminate cross-talk between the first and second group of ions at the detector 150. The detected ion data can be stored in memory and analyzed by a computer or computer software (not shown).

It will be appreciated by a person skilled in the art that the sample inlet system 110 and the ion source 120 coupled thereto can be any suitable sample inlet system and ion source known in the art or hereafter developed and modified in accordance with the present teachings. For example, the sample inlet system 110 can perform sample preparation/sample processing using a liquid chromatography (LC) column and/or serve as a reservoir for containing a sample to be delivered to the ion source 120 (e.g., via one or more pumps, conduits, valves, etc.). Though the inlet system 110 and the ion source 120 are depicted as separate elements, it will be appreciated that the inlet system 110 and the ion source 120 can be integrated. By way of non-limiting example, the inlet system 110 and the ion source 120 can comprise an electrospray source with the ability to generate ions from a sample analyte dissolved in solution. Other exemplary arrangements of the sample inlet system 110 and the ion source 120 include atmospheric pressure chemical ionization (APCI), atmospheric pressure photo-ionization (APPI), direct analysis in real time (DART), desorption electrospray (DESI), atmospheric pressure matrix-assisted laser desorption ionization (AP MALDI), multimode ionization sources, or configurations with multiple inlet systems and/or sources.

In certain embodiments, a sample (e.g., a sample containing one or more compounds/analytes of interest) can be inserted into the sample analysis system 100 through sample inlet system 110 to be ionized by the ion source 120, and the sample ions can be transported through the ion mobility filter 130, for example, under the influence of a flow of gas 132 and/or via an axially-directed electrical field. Those with skill in the art will understand that a counter-current gas flow (e.g., a curtain gas) in the region between the ion source 120 and the inlet of the ion mobility filter 130 can also be used in some aspects to decluster ions and prevent neutrals from entering downstream components. The ion mobility filter 130 receives the plurality of ions and separates a desired group or groups of ions from the sample based on the mobility, or velocity of ion species through the ion mobility filter 130. It will be appreciated, for example, that the mobility of a particular ion species is dependent upon a number of parameters including size and shape such that the ion mobility filter 130 can, in some aspects, enable the separation of isobaric compounds over time so that different ions with identical masses can be differentiated or separated prior to being transmitted to the detector 150. It will be appreciated that the ion mobility filter 130 used in the mass spectrometer system 100 of FIG. 1 may be any continuous beam ion mobility device known to one of skill in the art (e.g., FAIMS, DMS, DMA, etc.), and modified in accordance with the present teachings. Though detector 150 (e.g., a Faraday cup or other ion current measuring device such as a mass spectrometer) is shown as being disposed directly at the outlet of the ion mobility filter 130 so as to detect the ions transmitted by the ion mobility filter 130, it will be appreciated that the any number of ion optical elements can be disposed between the ion mobility filter 130 and the detector 150, for example, within a vacuum chamber that is effective to draw the gas flow 132 through the ion mobility filter 130.

As shown in FIG. 1, the sample analysis system 100 can also include a controller 160 that can be operatively connected to one or more of the sample inlet system 110, the ion source 120, the ion mobility filter 130, the ion removal mechanism 140, and the detector 150 for controlling operation thereof. By way of example, the controller 160 can be operatively coupled to the ion mobility filter 130 so as to control the mobility filter settings to select for a particular ion species from the sample, as discussed in detail below. Additionally, as shown, the controller 160 can include a timer 162 that can be used to define and synchronize time periods for functional operation of sample analysis system 100. For example, timer 162 can define one or more specific time periods for passing ions through the ion mobility filter 130 to the detector 150, as well as one or more specific time periods for operating the ion removal mechanism 140 for removing residual ions from the ion mobility filter 130. It will be appreciated in light of the present teachings that, during operation of sample analysis system 100, the plurality of operational time periods defined by the timer 162 can occur in various combinatorial sequences. For example, in various embodiments, three distinct time periods can be defined by timer 162: a first time period for selectively filtering a first group of ions with the ion mobility filter 130 and transmitting the first group of ions to the detector 150, a second time period for emptying residual ions from the ion optics assembly, and a third time period for selectively filtering a second group of ions and transmitting the second group of ions to the detector 150, wherein the second time period occurs between the first and third time periods. In various embodiments, the sequence of the time periods defined by the timer 162 discussed above can occur one or more times, with each transmission period, for example, allowing for the filtering of a selected group of ions by the ion mobility filter.

As noted above, the continuous beam ion mobility filter can have a variety of configurations, but is generally configured to filter ions based on their mobility characteristics, through a fixed or variable electric field (whereas MS analyzes ions based on their mass-to-charge ratios). With reference now to FIGS. 2A-C, operation of an exemplary DMS and ion removal mechanism suitable for use as the ion mobility filter 130 and ion removal mechanism 140 of FIG. 1 will now be described.

The exemplary DMS 230 depicted in FIG. 2C separates the ions in a drift gas based on their mobility when subject to an asymmetric electric field generated between at least two parallel electrodes 234a,b through which the ions pass, typically, in a continuous manner. In DMS, the electric field waveform typically has a high field duration at one polarity and then a low field duration at an opposite polarity. The duration of the high field and low field portions can be applied such that the net voltage being applied to the DMS filter electrodes is zero. Such an electric field can be generated, for example, through the application of RF voltages, often referred to as separation voltages (SV), across the drift tube in a direction perpendicular to that of a drift gas flow. Ions of a given species tend to migrate radially away from the axis of the transport chamber by a characteristic amount during each cycle of the RF waveform due to differences in mobility during the high field and low field portions. With specific reference to FIG. 2A, a plot 210 of an exemplary, time-varying, RF, and/or asymmetric high and low voltage waveform 214 that can be applied to generate an asymmetric electric field is depicted. Although the waveform of FIG. 2A is depicted as a square-wave function, it will be apparent to those of skill in the relevant arts that other waveform shapes are possible, including waveforms constructed by summation of two sine waves, by way of non-limiting example.

In DMS, a DC potential is also applied to the electrodes 234a,b, with the difference in DC potential between the electrodes commonly referred to as a compensation voltage (CV or CoV) that generates a counteracting electrostatic force to that of the SV. The CV can be tuned so as to preferentially prevent the drift of a species of the ion(s) of interest. Depending on the application, the CV can be set to a fixed value to pass only an ion species with a particular differential mobility while the remaining species of ions drift toward the electrodes and are neutralized thereat. Alternatively, if the CV is scanned for a fixed SV as a sample is introduced continuously into the DMS, a mobility spectrum can be produced as the DMS transmits ions of different differential mobilities over time. FIG. 2B depicts a plot 220 of an example of exemplary DC offset voltages 224a,b that are applied to filter electrodes 234a,b. As shown in FIG. 2B, the CoV in the DMS 230 is initially set to +5V (i.e., 50V−45V), which at time t₁ is increased to +100V. It will be apparent to those of skill in the relevant arts that the magnitude of the compensation field directly affects the ion drain time from the DMS analyzer. For this example, a CoV magnitude of 100 V was used with a 1 mm DMS gap. Increasing the CoV further (i.e., greater than 100 V) would drain the ions quicker.

With reference now to FIG. 2C, the combined effect of the electric fields generated by the waveforms in FIGS. 2A and 2B is shown in schematic representation for two species of ions. For the first species, the ion's mobility in the asymmetric electric field indicates a net movement 103 towards the bottom electrode 234b of the DMS 230 in the time period between times t₀ and t₁. (It should be appreciated in view of the depicted motion of the first species that, in a DMS, the ion's mobility is not constant under the influence of the low electric field compared to the high electric field.) However, for the second ion species, the CoV applied to the filter electrodes 234a,b has been tuned such that the second ion species maintains a safe trajectory 104 for the ion through the DMS 230 without striking one of the filter electrodes 234a,b during the time period between t₀ and t₁ to allow, for example, detection by the detector 150 of FIG. 1. It will be appreciated that trajectory 104 is averaged over a full cycle of the waveform, such that trajectory 104 does not show ion oscillations for each period of the waveform.

At time t₁ (e.g., in a second time period at t>t₁), the controller 160 can operate the ion removal mechanism 140 in accordance with various aspects of the present teachings to increase the CoV between the filter electrodes 234a,b such that substantially all of the ions within the DMS 230 (or entering the inlet end of the DMS 230, including the ions having a safe trajectory 104 for t<t₁) are deflected 105 to filter electrode 234b and neutralized thereat. Upon substantially clearing all ions from the DMS 230, the CoV can then be reset to a value tuned to allow a particular species to be selectively transmitted to the detector 150. In such a manner, the DMS can be operated to receive a continuous beam of ions from an ion source and serially filter a selected species, while eliminating cross-talk between the species (e.g., such that a first species of ions does not interfere with the detection or quantitation of a subsequent species transmitted thereafter).

Though the above description of FIGS. 2A-2C is made with reference to an ion removal mechanism 140 that operates to remove residual ions from the ion mobility filter 130 using the exemplary electrical means described, a person skilled in the art will appreciate in light of the present teachings that ion removal mechanisms that utilize alternative electrical signals, or mechanical removal, or pneumatic removal of residual ions can be employed. By way of example additional electrodes may be used to provide radially defocusing electric fields for ion removal. Alternatively, the transport gas flow through the DMS can be reduced or eliminated, or additional gas flows can be provided radially or counter-current to the ion motion to effectively drain ions from the mobility device.

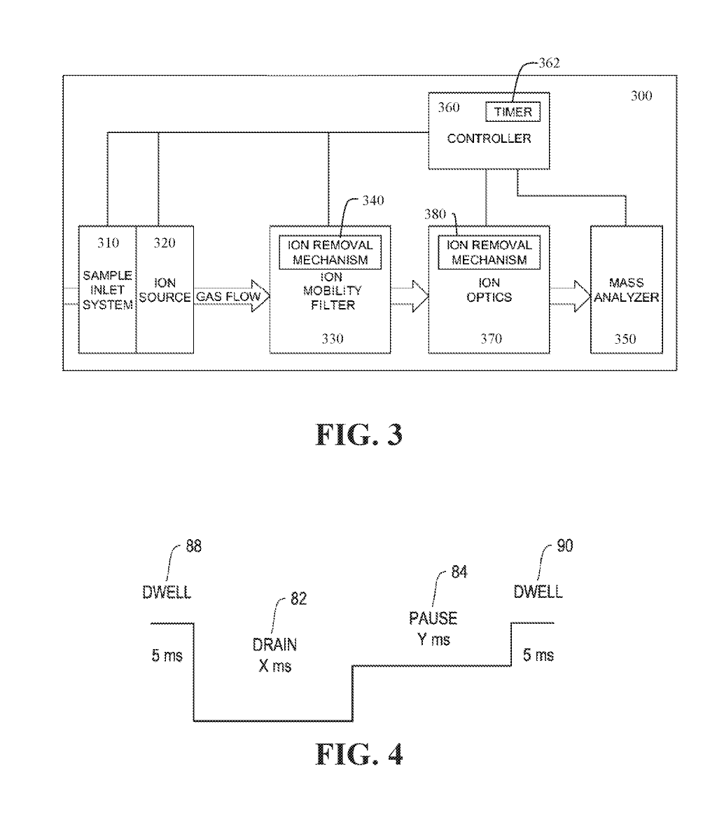

With reference now to FIG. 3, another exemplary sample analysis system 300 in accordance with various aspects of the present teachings is depicted in schematic view. The depicted mass spectrometer system 300 is like the sample analysis system 100 of FIG. 1 in that it includes a sample inlet system 310, ion source 320, ion mobility filter 330, ion removal mechanism 340, controller 360, and timer 362. However, the mass spectrometer system 300 as depicted in FIG. 3 additionally includes an ion optics assembly 370 and one or more mass analyzer(s) 350, which can also be operatively coupled to the controller 360. Further, the depicted ion optics assembly 370 can also comprise a second ion removal mechanism 380 for removing residual ions from the ion optics assembly 370. For example, the controller can be operatively coupled to the ion optics assembly 370 and the ion removal mechanism 380, and can control the application of RF and DC potentials to both so as to remove residual ions from the ion optics assembly 370 as discussed below, and in further detail in U.S. Pat. No. 8,350,212, which is incorporated by reference in its entirety.

In some aspects, after receiving the ions transmitted by the ion mobility filter 330 (e.g., as discussed above with reference to FIG. 1), the ion optics assembly 370 can use RF fields to focus the ions to an ion optical path and direct the ions toward the mass analyzer(s) 350. It will be appreciated that the ion optics assembly used in system 300 can include any ion optics known to one of skill in the art (e.g., multipole array, ring guide, resistive ion guide, ion funnel, travelling wave ion guide). After exiting the ion optics assembly 370, the ions travel via ion optical path to mass analyzer(s) 350, where ions can be separated based on their mass-to-charge ratios (m/z), for example, and detected. The detected ion data can be stored in memory and analyzed by a computer or computer software (not shown). The controller 360 is coupled to mass analyzer 350 to control the operation thereof.

In addition to controlling operation of the ion mobility filter 330 so as to control the mobility filter settings to select for a particular ion species from the sample, as discussed above, the controller 360 can additionally be used to define and synchronize time periods for operating the first and second ion removal mechanisms 340, 380. For example, the timer 362 can define one or more specific time periods for passing ions through the ion mobility filter 330 and ion optics assembly 370 to the mass analyzer(s) 350, as well as one or more specific time periods for operating the ion removal mechanisms 340, 380 for removing residual ions from the ion mobility filter 330 and ion optics assembly 370, respectively. It will be appreciated in light of the present teachings that, during operation of sample analysis system 300, the plurality of operational time periods defined by the timer 362 can occur in various combinatorial sequences.

With reference now to FIGS. 4-6, an exemplary technique for removing ions from an exemplary ion optics assembly will be described. FIG. 4 depicts an exemplary timing diagram for operation of an ion removal mechanism 380 depicted in FIG. 3, having four distinct periods: a drain time 82, pause time 84, and dwell times 88, 90; the removal of residual ions from the ion optics assembly 370 depicted in FIG. 3 occurs during the drain time 82. During dwell time 88 of FIG. 4, an exemplary quadrupole ion optics array 60 suitable for inclusion in the ion optics assembly 370 of FIG. 3 is depicted in FIG. 5 in a configuration configured to transmit/focus ions. It will be appreciated that though array 60 is depicted as a quadrupole, it can be an octapole, hexapole or any other multipole as known in the art. For the purposes of this exemplary illustration, ion optics array 60 is a Q0 RF ion guide, though it will be appreciated by those skilled in the art that optics array 60 could be a QJet RF ion guide, or one of various other ion optics configurations known in the art. As shown, ion optics array 60 comprises quadrupole rods 62A-D, with a power supply 61 connected to rods 62A-D and for applying RF and DC voltages thereto. It will be appreciated that the power supply 61 can also be controlled by controller 360 of FIG. 3 to apply a range of distinct DC and RF voltages to each of the rods 62A-D in ion optics array 60. In this illustrative example, when the Q0 ion optics 60 are operating during dwell time 88 to transport and focus ions to an ion optical path, each rod has a −10 V DC voltage applied to it. Rods 62A and 62C have identical RF voltages (RF_{A}) applied to each so as to create an RF_{A} field between the rod pair, whereas rods 62B and 62D have identical RF voltages (RF_{B}) applied to each so as to create a RF_{B} field between the rod pair. It will also be appreciated that RF fields within the quadrupole array can be combined with superimposed DC voltages to focus ions within the optics array 60.

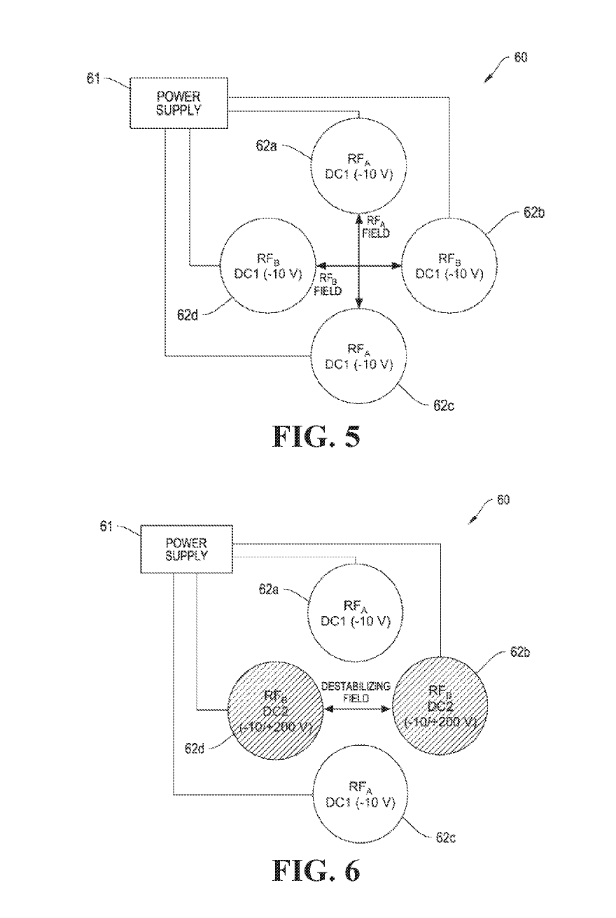

After dwell time 88, a drain period 82 can be initiated as shown in FIG. 4. FIG. 6 depicts ion optics array 60 during an ion draining period. In FIG. 6, the optics array 60 and power supply 61 are configured to operate an ion removal mechanism by applying a DC potential to quadrupole rods 62B and 62D that is increased relative to the other poles (i.e., +200 V) during the drain period 82 so as to apply an unbalanced resolving DC potential onto the quadrupole electrodes 62A-D. The DC potential can be controlled by a controller (e.g., controller 360 of FIG. 3) and applied by power supply 61 to rods 62B and 62D. The increased DC potential applied to quadrupole rods 62B and 62D creates a destabilizing electric field between the poles to overcome the focusing field applied by optics array 60 and expel ions, including residual ions, away from the ion optical path. For example, the second ion removal mechanism 380 can eliminate, or substantially eliminate residual ions by causing the ions to collide with one of the quadrupole rods 62A-D or fly out between the quadrupole rods as a result of gas flow. It will be appreciated that the ion optics assembly can have a variety of other configurations as well, as described for example by U.S. Pat. No. 8,350,212, which is incorporated by reference in its entirety. For example, ions can also be drained from the quadrupole array (60) by reducing the magnitude of the confining RF potential.

In comparing the timing diagram of FIG. 4 with that of FIGS. 2A-C, it will be appreciated in light of the present teachings that the controller 360 can synchronize the time periods for removing residual ions from the ion mobility filter 330 and ion optics assembly 370. By way of example, the ion mobility filter 330 can operate in transmission mode for a first species (i.e., prior to t₁ as shown in FIG. 2A) during the dwell time 88 of FIG. 4. At time t₁, the controller 360 can initiate removal of residual ions, for example, by increasing the CoV in the ion mobility filter 330 as shown in FIG. 2A, while simultaneously initiating the drain time 82 of FIG. 4. Upon draining residual ions from the ion mobility filter 330 and the ion optics assembly 370, the CoV applied to the filter electrodes can be tuned (e.g., reduced from +100V) such that a second ion species can be transmitted by the ion mobility filter 330. In some aspects, the pause time 84 of FIG. 4, which is depicted as having a variable length, can be adjusted to allow the gas flow to restabilize the ion current through the mobility cell as the mobility conditions are tuned.

With reference now to FIG. 7, another exemplary mass spectrometer system 700 in accordance with various aspects of the present teachings is depicted. Mass spectrometer system 700 comprises a source extension ring 722 (e.g., for connecting to an ion source), a curtain plate 732, a DMS mobility cell 730, and an orifice plate 772 having an inlet orifice 774 through which ions can be transmitted from the DMS mobility cell 730 operating at a relatively high-pressure (e.g., near atmospheric pressure) to the sub-atmospheric operating conditions of the ion optics/mass analyzer device 770. Curtain plate 732 fits over DMS mobility cell 730 and fastens onto orifice plate 772. The curtain plate 732 directs the curtain gas flow towards the ion source. A high-purity curtain gas (e.g., N₂) flows between curtain plate 732 and orifice plate 772 and aids in keeping the system 700 clean by desolvating and evacuating large neutral particles. As will be appreciated by a person skilled in the art, the outlet end of the DMS mobility cell 730 can be separated from the orifice plate 772 by an axial offset, thereby defining a coupling chamber through which ions transmitted by the DMS mobility cell pass before entering the inlet orifice 774. As will be appreciated by a person skilled in the art, the ion optics/mass analyzer device 770 can include one or more downstream mass analyzer elements in one or more differentially pumped vacuum stages. For instance, in one embodiment, a triple quadrupole mass spectrometer may comprise three differentially pumped vacuum stages, including a first stage maintained at a pressure of approximately 2.3 Torr, a second stage maintained at a pressure of approximately 6 mTorr, and a third stage maintained at a pressure of approximately 10⁻⁵ Torr. The third vacuum stage can contain a detector, as well as two quadrupole mass analyzers with a collision cell located between them. It will be apparent to those skilled in the art that there may be a number of other ion optical elements in the system. Alternatively, a detector (e.g., a Faraday cup or other ion current measuring device) effective to detect the ions transmitted by the DMS mobility cell 730 can be disposed directly at the outlet of the DMS mobility cell 730, or alternatively, within a vacuum chamber, for example, that can be effective to draw the gas flow through the ion mobility filter.

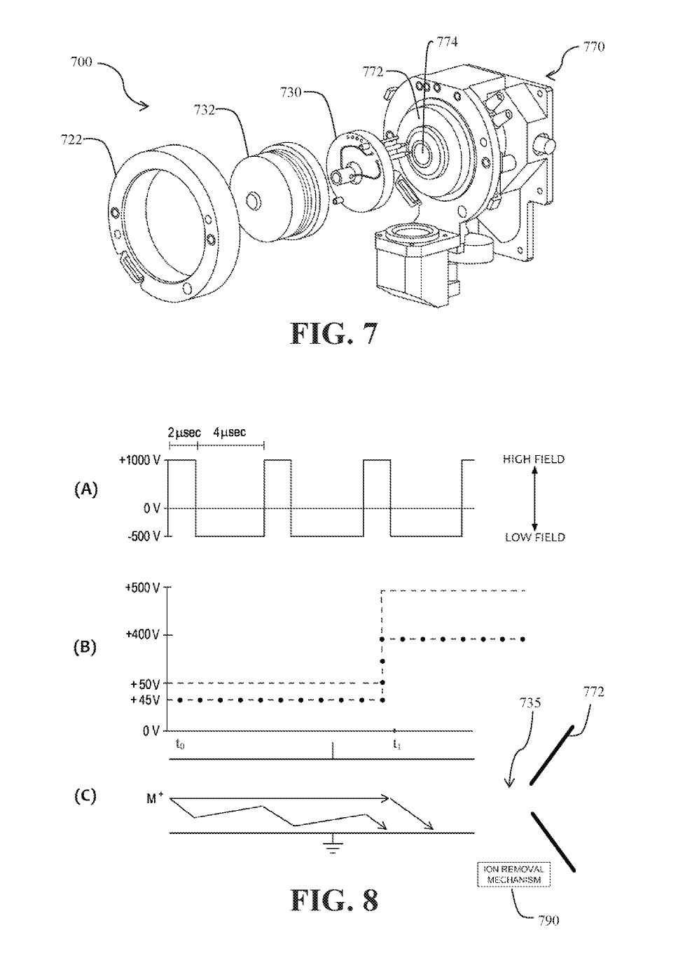

In addition to removing residual ions from the DMS mobility cell 730, applicant has discovered that an ion removal mechanism 790 for removing residual ions from the coupling region between the DMS mobility cell 730 and the orifice plate 772 can further help to reduce cross-talk. As such, residual ions within the coupling chamber can also be removed via an ion removal mechanism 790, as described below by way of non-limiting example with reference to FIGS. 8A-C.

As shown in FIG. 8C, the exemplary DMS mobility cell 730 and orifice plate 772 of FIG. 7 are depicted as being separated by the coupling region 735. The timing diagrams of FIGS. 8A and 8B are substantially similar to those of FIGS. 2A and 2B, but differ in that in addition to increasing the CoV after time t₁, the ion removal mechanism 790 increases the offset DC voltages applied to filter electrodes 834a,b (up to 400 V greater than the orifice plate potential). Higher offset potentials reduced the measured cross-talk. By way of non-limiting example, the CoV in the DMS 730 is initially set to +5V (i.e., 50V-45V), which at time t₁ is increased to +100V (the same CoV as in FIG. 2A). However, the offset DC voltage are also increased at this time such that the DMS filter 730 is maintained at a substantially higher potential after time t₁ relative to the potential applied to the orifice plate 772. In such a manner, the axial electric field generated by the increase in offset voltage can be effective to generate an axial electric field that accelerates ions within the coupling region 735 toward and/or through the inlet plate 772 and inlet orifice 774. Thus, by initiating the residual ion removal (e.g., at time t₁) concurrent with the draining of the downstream ion optics assembly (e.g., initiating drain time 82 of FIG. 4), ions within the DMS mobility cell 730 can be neutralized by the filter electrodes after t₁, while substantially all ions within the ion optics assembly, including those ions swept therein from the coupling region by the increased DMS offset voltages, will likewise be removed. Because of the neutralization of the ions within the DMS cell 730 and the reduction in residence time for ions within the coupling region 735 by utilizing ion removal mechanisms in accordance with various aspects of the present teachings, cross-talk between ionic species can be reduced without substantial detriment to the duty cycle (e.g., by merely increasing drain time of ions within the ion optics assembly). It will also be appreciated in light of the present teachings, that ions can additionally or alternatively be removed from the coupling region 735 pneumatically, for example, by altering the flow of gas therethrough, or by providing additional gas flows to disrupt ion motion. In other aspects ions can be removed mechanically by providing blocking or diverting devices or shutters.

Aspects of the applicant's teachings may be further understood in light of the following examples, which should not be construed as limiting the scope of the applicant's teachings in any way. Additionally, teachings from each example can be combined without departing from the scope of the invention.

### Example 1

In current ion mobility devices coupled to a downstream mass analyzer via an ion optics assembly, a small population of ions may not be transmitted to the ion optics assembly during the drain period due to increased residence times within the DMS cell and the coupling chamber located between the ion mobility cell and inlet orifice. These residual ions can result in a small, but measurable cross-talk signal in subsequent isobaric transitions, unless the drain time is increased prior to measuring the next period. Indeed, applicant has found that significant cross-talk can still be observed, even with drain times as long as 10 ms (and pauses of 15 ms), as shown Table 1 below, depicting % Crosstalk for ions having 1522 m/z and 2122 m/z.

TABLE 1
% Crosstalk for 1522 m/z and 2122 m/z ions as function of drain time
High m/z with 15 ms pause

| Drain Time (ms) | 1522 Cross Talk | 2122 Cross Talk |
|---|---|---|
| 2 | 0.294663 | 0.29637 |
| 4 | 0.15485 | 0.16687 |
| 6 | 0.0814 | 0.111884 |
| 8 | 0.049374 | 0.078904 |
| 10 | 0.02653 | 0.054214 |

% Crosstalk is calculated for each drain time according to:

$$\% CrossTalk = ( \frac{CrossTalk}{Analytical Signal} ) \times 100 \%$$

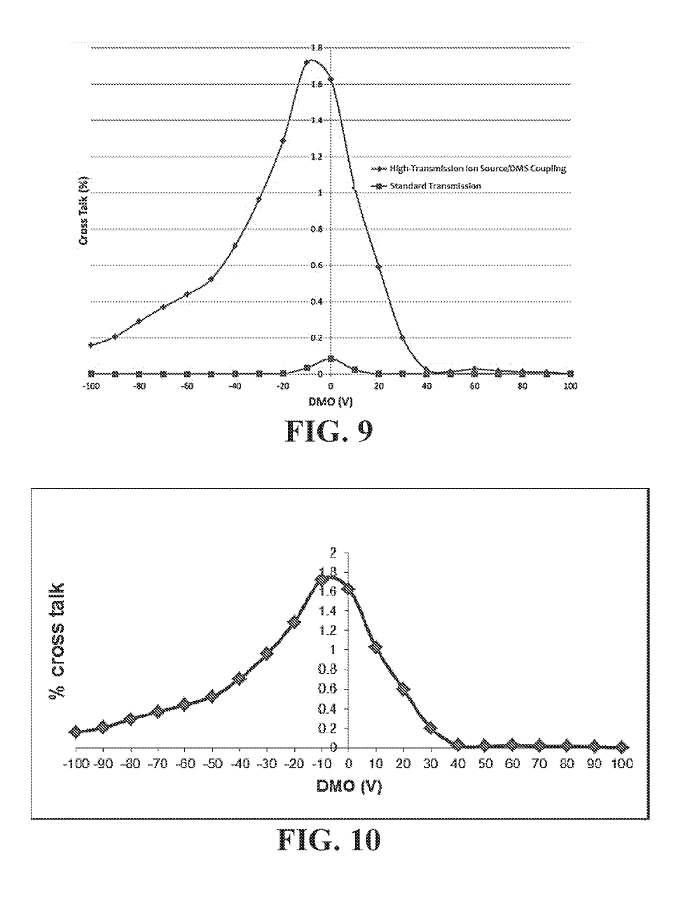

Such issues can also be exacerbated by the development of DMS cells which provide for improved transmission from the ion source into the ion mobility filter (e.g., as described in U.S. Provisional Application Nos. 61/922,275, filed Dec. 31, 2013, and 61/935,741 filed Feb. 4, 2014, both entitled “Jet Injector Inlet for a Differential Mobility Spectrometer” and incorporated by reference herein). For example, FIG. 9 depicts a substantial increase in % Crosstalk when using a DMS cell designed to provide different gas flow rates to different regions of the cell relative to a conventional DMS cell (i.e., “standard transmission”). Further, the cross-talk issue can be compounded by techniques that increase the residence time of ions within the ion mobility filter (or the coupling region), including the use of negative DC offset values (as shown for example in FIG. 10) and/or by axially-extended coupling regions (e.g., doubling the length of coupling region doubles residence time and substantially increases % Crosstalk). However, in a system such as that depicted in FIG. 7, a substantial improvement in % Crosstalk was observed by increasing the DMO potential and CoV, as demonstrated in the following tables providing exemplary data of % Crosstalk for both positive and negative ions of various m/z. For the data in Tables 2 and 3 below, a 2 ms drain time was used in the ion optics assembly (e.g., as shown in FIG. 4), during which the CoV was set to 100 V and the DMO potential was adjusted to values between 100 and 400 V. As the tables demonstrate, cross-talk decreased with an increase in the DMO, from an initial value (no drain) of around 2% to a minimum of 0.007% (for the ion with the highest m/z) with DMO potential of 400 V (i.e., at least 286× reduction).

TABLE 2
% Crosstalk for positive ions
System 1

| DMO (V) | m/z 118 | m/z 622 | m/z 922 | m/z 1522 |
|---|---|---|---|---|
| 100 | 0.000 | 0.059 | 0.133 | 0.325 |
| 200 | 0.000 | 0.000 | 0.002 | 0.030 |
| 300 | 0.000 | 0.000 | 0.000 | 0.002 |
| 400 | 0.000 | 0.000 | 0.000 | 0.000 |

TABLE 3
% Crosstalk for negative ions
System 1

| DMO on | | | | | | m/z |
|---|---|---|---|---|---|---|
| drain (V) | m/z 585 | m/z 933 | m/z 1223 | m/z 1572 | m/z 1863 | 1979 |
| 100 | 0.103 | 0.217 | 0.277 | 0.308 | 0.352 | 0.389 |
| 200 | 0.009 | 0.018 | 0.032 | 0.068 | 0.097 | 0.131 |
| 300 | 0.004 | 0.006 | 0.008 | 0.009 | 0.016 | 0.021 |
| 400 | 0.002 | 0.003 | 0.003 | 0.003 | 0.006 | 0.007 |

Those skilled in the art will know or be able to ascertain using no more than routine experimentation, many equivalents to the embodiments and practices described herein. Accordingly, it will be understood that the invention is not to be limited to the embodiments disclosed herein, but is to be understood from the following claims, which are to be interpreted as broadly as allowed under the law.

The section headings used herein are for organizational purposes only and are not to be construed as limiting. While the applicant's teachings are described in conjunction with various embodiments, it is not intended that the applicant's teachings be limited to such embodiments. On the contrary, the applicant's teachings encompass various alternatives, modifications, and equivalents, as will be appreciated by those of skill in the art.

1. A sample analysis system, comprising:
a continuous beam ion mobility filter for receiving ions from an ion source, said ion mobility filter configured to filter and transmit a first group of ions therethrough;
a mass analyzer housed within a vacuum chamber and in fluid communication with the ion mobility filter for analyzing the first group of ions;
a coupling region disposed between an outlet end of the ion mobility filter and an inlet orifice of the vacuum chamber for transporting the first group of ions from the ion mobility filter to an inlet orifice of the vacuum chamber; and
an ion removal mechanism for removing residual ions from at least one of the ion mobility filter and the coupling region.

2. The sample analysis system of claim 1, further comprising an ion optics assembly for transporting the first group of ions from the ion mobility filter to the mass analyzer.

3. The sample analysis system of claim 2, further comprising a controller operatively coupled to the ion mobility filter, the ion optics assembly, and the mass analyzer for controlling operation thereof, wherein the controller comprises a timer for defining at least a first period representative of a time for passing the first group of ions through the ion mobility spectrometer, and at least a second period for operating the ion removal mechanism to remove residual ions from the ion mobility filter and the coupling region.

4. The sample analysis system of claim 3, further comprising a second ion removal mechanism for removing ions from the ion optics assembly.

5. The sample analysis system of claim 4, wherein the controller is in communication with the second ion removal mechanism for decreasing an RF potential within the ion optics assembly to de-focus and remove ions from within the ion optics assembly during the second period.

6. The sample analysis system of claim 1, wherein the ion mobility filter is located in a first pressure region, the mass analyzer is located in a second pressure region different from the first pressure region, and the ion optics assembly is located in a third pressure region intermediate to the pressures in the first and second pressure regions.

7. The sample analysis system of claim 24, wherein the first pressure region is near atmospheric pressure.

8. The sample analysis system of claim 1, wherein the ion mobility filter is selected from the group consisting of FAIMS, DMS, and DMA.

9. The sample analysis system of claim 1, wherein the ion mobility filter comprises:
at least one pair of filter electrodes defining an ion flow path therebetween, the filter electrodes configured to generate an electric field for passing through the first group of ions based on the mobility characteristics of the first group of ions; and
a voltage source for providing RF and DC voltages to at least one of the filter electrodes to generate the electric field.

10. The sample analysis system of claim 9, further comprising a controller operatively coupled to the ion mobility filter for controlling operation thereof, wherein the controller comprises a timer for defining at least a first period representative of a time for passing through the first group of ions, and at least a second period for operating the ion removal mechanism to remove residual ions from the ion mobility filter and the coupling region.

11. The sample analysis system of claim 10, wherein the controller is configured to increase a DC bias voltage applied between the filter electrodes during the second period relative to the first period such that substantially all ions within the ion mobility filter are neutralized at the filter electrodes during the second period.

12. The sample analysis system of claim 11, wherein the controller is configured to increase an amplitude of a DC offset voltage of the at least one pair of filter electrodes relative to the inlet orifice during the second period relative to the first period.

13. The sample analysis system of claim 1, wherein the ion removal mechanism is configured to increase an axial velocity of ions within the coupling region.

14. The sample analysis system of claim 1, wherein the ion removal mechanism increases a compensation voltage applied between electrodes of the ion mobility filter and an amplitude of a DC offset voltage of the electrodes relative to the inlet orifice.

15. The sample analysis system of claim 1, wherein the first groups of ions are entrained in a gas flow through the ion mobility filter.

16. The sample analysis system of claim 1, wherein the first group of ions are driven through the ion mobility filter by an axial electric field.

17. The sample analysis system of claim 1, wherein the vacuum chamber maintains the mass spectrometer at a vacuum pressure lower than an internal operating pressure of the ion mobility filter, the vacuum chamber being operable to draw a gas flow including the first group of ions through the ion mobility filter and into the vacuum chamber via the inlet orifice.

18. The sample analysis system of claim 1, further comprising an ion source for generating the first group of ions.

19. A method for analyzing a sample, comprising:
A. filtering, based on ion mobility, a first portion of ions using a continuous beam ion mobility filter coupled to a vacuum inlet orifice of a mass analyzer and transmitting, using an ion optics assembly, the first portion of ions to the mass analyzer during a first time period;
B. filtering, based on ion mobility, a second portion of ions and transmitting, using the ion optics assembly, the second portion of ions to the mass analyzer during a second time period; and
C. emptying residual ions from the ion mobility filter and the ion optics assembly during a third time period, the third time period occurring between the first and second time periods; and
iteratively repeating steps A-C.

20. The method of claim 19, wherein a coupling chamber is disposed between the ion mobility filter and the vacuum inlet orifice, and wherein residual ions within the coupling chamber are removed therefrom during the third time period, and optionally wherein residual ions within the coupling chamber are accelerated toward the vacuum inlet orifice.
